(19) United States
(12) Patent Application Publication
(10) Pub. No.: US 2005/0031804 A1
(43) Pub. Date: Feb. 10, 2005

(54) Systems and methods for adorning persons and things

(76) Inventor: Shawn D. Majors, Hemet, CA (US)

Correspondence Address: BIOTECHNOLOGY LAW GROUP, 658 MARSOLAN AVENUE, SOLANA BEACH, CA, 92075, US

(21) Appl. No.: 10/879,828

(22) Filed: Jun. 29, 2004

Related U.S. Application Data
(60) Provisional application No. 60/493,877, filed on Aug. 7, 2003.

(51) Int. Cl. B60R 13/00

(52) U.S. Cl. 428/31

(57) ABSTRACT

Means for reversibly engaging ornaments onto articles of manufacture are described.

### CROSS-REFERENCE TO RELATED APPLICATIONS

This application is related to, claims priority to and incorporates by reference United States Provisional Patent Application, Ser. No. 60,493,877, filed Aug. 8, 2003, which is entitled the same. This application is also related to United States Design Patent Application, Ser. No. 29/187,926, filed Aug. 7, 2003, and entitled “SPIDER ORNAMENT FOR USE ON CLOTHING, AS JEWELRY, AND/OR AS VEHICLE ADORNMENT,” which disclosure is herein incorporated by reference in its entirety, including all drawings.

### BACKGROUND ART

Hood ornaments on cars serve to distinguish the make or model of the car and are typically permanently fastened using cables or other attachment means that must be broken or structurally compromised in order to remove the emblem/ornament. This is in large part due to the fear of theft and/or removal by miscellaneous forces that a car may encounter.

However, there are contexts in which a means for removing these emblems/ornaments without compromising the structure or visible integrity of the ornament, means for fastening such, or host automobile could be useful. For example, there is a present fad in the rap industry wherein artists and others wear chains having medallions and emblems similar in size to those traditionally appearing on automobiles. Such persons are also partial to riding motorcycles and “choppers,” which are frequently adorned with painted designs for show.

### SUMMARY OF THE INVENTION

Objects of the invention include one or more of 1) making a vehicular emblem/ornament more easily removable without substantially damaging it, the vehicle, or the fastening means thereto; 2) providing sufficient fastening so as to withstand wind forces at speeds typical of motor vehicles and other minor force perturbations; and 3) to allow for such ornaments to be readily releasable and transplantable to another decorative host, e.g., a human, another vehicle, or another article of manufacture.

In a first aspect, the invention features a hood, trunk or fuel tank ornament for a vehicle, said ornament comprising a) means for affixing and releasing said ornament at will from said automobile or motorcycle without substantially compromising the structural integrity thereof. The means may be selected from the group consisting of magnetic and mechanical fixation. The ornament may further comprise one or more precious metals or stones integral to said ornament, said precious metals or stones not compromising the structural integrity of said means for affixing and releasing said ornament.

In a second aspect, the invention features a necklace adapted to receive the ornament of the first aspect. The means for affixing may be the same or different as between the trunk, hood or gas tank and the necklace.

In a third aspect, the invention features a method for reversibly fastening an emblem or ornament to a vehicle, comprising (a) providing an emblem or ornament with a means for reversibly fastening to a vehicle; and (b) fastening said ornament to said vehicle using said means. The means can be magnetic or mechanical, and the same or different means can also be employed to fasten to a necklace, chain, hat or belt when not in use on vehicles.

In a fourth aspect, the invention features a kit comprising the ornament of the first aspect and one or more of a) a necklace according to the second aspect, b) instructions on how to use said ornament, c) one or more magnets, d) one or more tools or instructions for modifying said hood, trunk or fuel tank to receive said ornament for display, and e) a modified hood, trunk, or fuel tank adapted to receive said ornament for display.

In some preferred embodiments of the above aspects, the ornament comprises a substantially two- or three-dimensional hour-glass design, said hour-glass design optionally red and further optionally part of a spider figure. In certain other embodiments, the ornament is simply of a spider figure.

In some particularly preferred embodiments, the vehicle is a motorcycle.

For magnetic means of fastening, the ornament can comprise in whole or in part a magnet, or else be fashioned of a material that is attracted to a magnet. The magnetic force should be strong enough to withstand wind and other perturbations when in normal use, but no so strong as to not be disengageable at will be a human hand.

In one motorcycle embodiment, a steel gas tank is provided with a magnet on the exterior or interior of the tank and the ornament is made of a steel or metallic material attractable thereto using magnetic force. So as not to compromise a paint job, a clear transparent sticker can be overlaid on that portion of the tank that is to be overlaid with the ornament.

In some particularly preferred embodiments, the ornament comprises in whole or in part precious metals, and/or stones.

In another aspect, the invention features using insect or spider fangs or pincers to fasten to a necklace or other item.

Additional features and advantages of the invention will be apparent in the drawings, detailed description and claims to follow.

### BRIEF DESCRIPTION OF THE FIGURES

FIG. 1 is a top view corresponding to both one- and two-dimensional embodiments;

FIG. 2 is a side view, only appropriate for three-dimensional embodiments;

FIG. 3 is a bottom view, only appropriate for three-dimensional embodiments;

FIG. 4 is a front view, only appropriate for three-dimensional embodiments; and

FIG. 5 is a back view, only appropriate for three-dimensional embodiments.

FIG. 6 shows one embodiment of an ornament attached to a motorcycle gas tank.

FIG. 7a shows a “pin” embodiment for affixing an ornament to a motorcycle gas tank. FIG. 7b shows an adapter embodiment for receiving said pin.

### DETAILED DESCRIPTION OF THE PREFERRED EMBODIMENTS

The invention allows for reversibly fixing ornaments to a vehicle, such as a car or motorcycle. The ornament may have further “interchangeable” utility as personal jewelry, e.g., as part of a necklace or chain when not in use on the vehicle.

A preferred embodiment is a spider emblem or ornament embodying one or more of the above reversible fastening means. The ornament can be used for personal use, habitation, and/or vehicular adornment. Examples of personal adornment include, e.g., use as part of a necklace, ear-rings, other body-piercing rings, lapel pins, hat pins, crowns, etc. Although scale can be variable, because some aspects demand that physical display and exhibition on a vehicle be paramount, the size required for this might make impractical all but a necklace embodiment if the ornament is also to be used as personal adorning jewelry.

In a preferred embodiment, the ornament is that of a spider, e.g., a “Black Widow” spider.

### EXAMPLE 1

### Mechanical Adherence of Spider Ornament

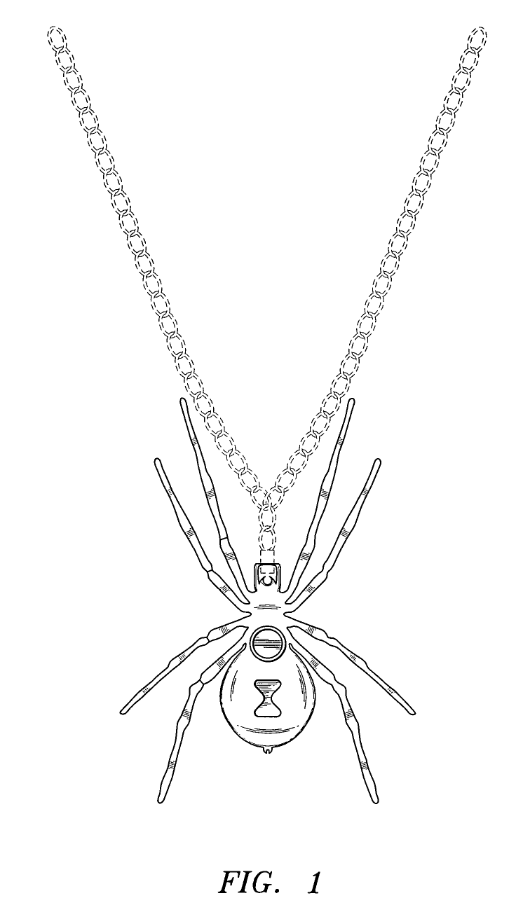

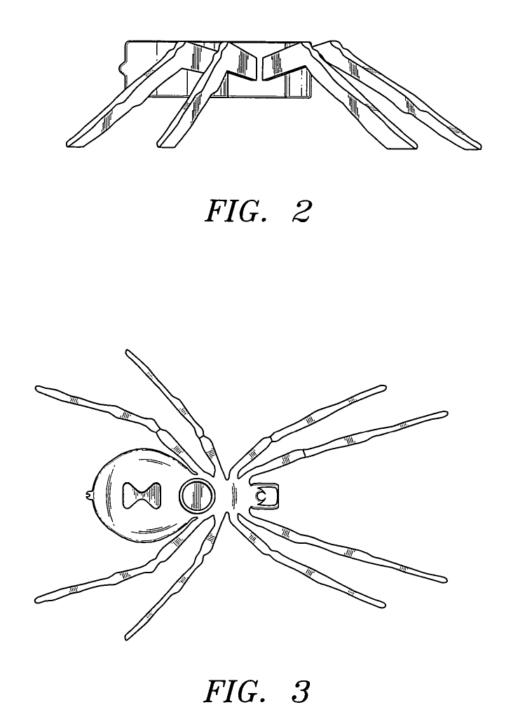

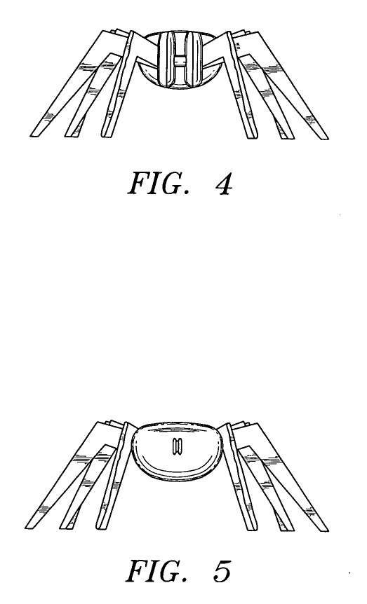

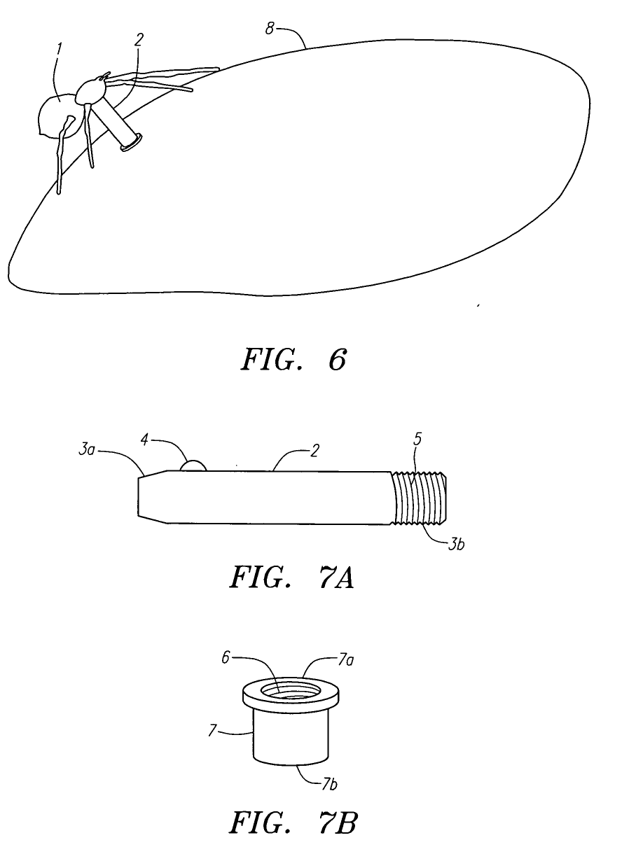

FIGS. 1-8 show a “pin and insert design” for a spider ornament that relies for fastening on a means much as used in the hardware tools industry, e.g., on socket wrenches, screw drivers, and the like. FIGS. 1-4 show, respectively, a top perspective view of the spider ornament 1, optionally attached to a necklace 9 via the spider's fangs 1a (FIG. 1), and side (FIG. 2), bottom (FIG. 3) front (FIG. 4) and back (FIG. 5) views of the spider ornament. FIG. 6 shows the ornament 1 fixed to the gas tank 8 of a motorcycle. FIG. 8 is a similar embodiment to FIG. 6. FIG. 3 shows a view of the underside of the spider ornament 1, which contains a recess 1a of size suitable to receive a pin of complementary dimension 2 (FIG. 6). The pin 2 has a first end 3a that inserts into the recess 2 to be removably fixed therein by means of a depressible ball 4 that engages the interior facing of said recess 2. The pin also has a second end 3b that is adapted to interface with a fuel tank 8 of a motorcycle, e.g., by way of threading 5. This threading 5 is complementary in dimension with the interior 6 of an adaptor 7 that has an outward facing portion 7a and an inward facing portion 7b. The adaptor 7 is fitted to the external facing of a motorcycle tank 8, e.g., by welding or other means, such that the pin 2 is screwed into the outward facing portion 7a, and whereas the inward facing portion 7b faces the interior of the tank.

Scale is shown but is not essential and can vary as between all features of the pin, ornament, etc. Upon removal, the ornament can then be transferred at will to a necklace or belt configured similarly with a pin and insert design.

The article may be fashioned in whole or in part from, or encrusted with, precious gems, e.g., diamonds, rubies, emeralds and/or sapphires, and/or precious metals, e.g., gold, silver, platinum, and/or copper.

### EXAMPLE 2

### Magnetic Adherence of Spider Ornament

The ornament described in Example 1 can, alternatively or conjunctively, be made in whole or part from a magnetizable metal or magnet that allows it to affix to a counterpart adorning surface of a vehicle, e.g., a motorcycle gas tank. Rare earth magnets, for example, are extremely strong, available from a variety of commercial sources over the internet, and can be molded or fashioned into a variety of sizes and shapes for use with appropriate aspects and embodiments of the invention. The best way to release them is to “slide” them perpendicular to the magnetic force while simultaneously applying outward force as well. The emblem can then be transferred at will to a necklace configured with a magnet or piece of magnetizable metal, e.g., steel, such that the ornament will “attract” and adhere to the necklace. One or more of the pin design and ornament recess of Example 1 can further be modified to accept a magnet if desired.

The foregoing examples are not limiting and are merely representative of various aspects and embodiments of the present invention. All documents cited are indicative of the levels of skill in the art to which the invention pertains. The disclosure of each document cited is incorporated by reference herein to the same extent as if each had been incorporated by reference in its entirety individually, although none of the documents is admitted to be prior art.

One skilled in the art will readily appreciate that the present invention is well adapted to carry out the objects and obtain the ends and advantages mentioned, as well as those inherent therein. The methods and compositions described illustrate preferred embodiments, are exemplary, and are not intended as limitations on the scope of the invention. Certain modifications and other uses will occur to those skilled in the art, and are encompassed within the spirit of the invention, as defined by the scope of the claims.

The invention illustratively described herein suitably may be practiced in the absence of any element or elements, limitation or limitations which is not specifically disclosed herein. Thus, for example, in each instance herein any of the terms “comprising”, “consisting essentially of” and “consisting of” may be replaced with either of the other two terms, and each has a different meaning within the patent laws. The terms and expressions which have been employed are used as terms of description and not of limitation, and there is no intention in the use of such terms and expressions of excluding any equivalents of the features shown and described, or portions thereof. It is recognized that various modifications are possible within the scope of the invention claimed. Thus, it should be understood that although the present invention has been specifically disclosed by preferred embodiments, optional features, modifications and variations of the concepts herein disclosed may be resorted to by those skilled in the art, and that such modifications and variations are considered to be within the scope of this invention as defined by the description and the appended claims.

In addition, where features or aspects of the invention are described in terms of Markush groups or other grouping of alternatives, those skilled in the art will recognize that the invention is also thereby described in terms of any individual member or subgroup of members of the Markush group or other group, and exclusions of individual members as appropriate.

Other embodiments are within the following claims.

1. A hood, trunk or fuel tank ornament for a vehicle, said ornament comprising
a) means for affixing and releasing said ornament at will from said automobile or motorcycle without substantially compromising the structural integrity thereof, said means selected from the group consisting of magnets and mechanical fixation; and optionally further comprising
b) one or more precious metals or stones integral to said ornament, said precious metals or stones not compromising the structural integrity of said means for releasing said ornament.

2. A necklace adapted to receive the ornament of claim 1.

3. The hood of claim 1 wherein said means for releasing is magnetic.

4. The necklace of claim 1 wherein said adaptation uses magnetism to affix said ornament to said necklace and said hood, trunk, or fuel tank.

5. The hood, trunk or fuel tank ornament of claim 1 wherein said means for affixing and releasing said ornament is mechanical.

6. The necklace of claim 4 wherein said adaptation uses mechanical association to affix said ornament to said necklace and said hood, trunk, or fuel tank.

7. The ornament of claim 1 wherein said means for affixing and releasing is the same for said hood, trunk, or fuel tank and said necklace.

8. The ornament of claim 1 wherein said ornament comprises an hour-glass design, said hour-glass design optionally red and further optionally part of a spider figure.

9. A method of reversibly fastening an emblem or ornament to a vehicle, comprising:
providing an emblem or ornament with a means for reversibly fastening to a vehicle; and
fastening said ornament to said vehicle using said means.

10. The method of claim 9 wherein said means is magnetic.

11. The method of claim 9 wherein said means is mechanical.

12. The method of claim 9 wherein said emblem or ornament further comprises a means for fastening to a necklace or chain.

13. The method of claim 12 wherein said means for fastening to said vehicle and said necklace are the same.

14. The method of claim 9 wherein said vehicle is a motor vehicle.

15. The method of claim 14 wherein said motor vehicle is a motorcycle.

16. The method of claim 15 wherein the situs of fastening is said gas tank on said motorcyle.

17. The method of claim 16 wherein said ornament comprises an hour-glass design, said hour-glass design optionally red and further optionally part of a spider figure.
